(19) United States
(12) Patent Application Publication
(10) Pub. No.: US 2026/0299229 A1
(43) Pub. Date: Oct. 1, 2026

(54) OPTICAL WAVEGUIDE DEVICE, AND OPTICAL MODULATION DEVICE AND OPTICAL TRANSMISSION APPARATUS USING SAME

(71) Applicant: SUMITOMO OSAKA CEMENT CO., LTD., Tokyo (JP)

(72) Inventors: Kosuke OKAHASHI, Tokyo (JP); Shingo TAKANO, Tokyo (JP)

(73) Assignee: SUMITOMO OSAKA CEMENT CO., LTD., Tokyo (JP)

(21) Appl. No.: 18/879,211

(22) PCT Filed: Sep. 27, 2023
(86) PCT No.: PCT/JP2023/035247

§ 371 Date: Dec. 26, 2024

(51) Int. Cl. G02B 6/42; H04B 10/50

(52) U.S. Cl. CPC G02B 6/4274; G02B 6/4246; H04B 10/501

(57) ABSTRACT

An object of the present invention is to provide an optical waveguide device that suppresses temperature drift in a portion in which patterns of an optical waveguide and an electrode are densely disposed.

An optical waveguide device of the present invention includes an optical waveguide substrate 1 on which an optical waveguide 10 is formed, a reinforcing substrate 11 disposed under the optical waveguide substrate 1, a lower buffer layer B1 disposed between the optical waveguide substrate 1 and the reinforcing substrate 11 to join both of the optical waveguide substrate 1 and the reinforcing substrate 11 to each other, and an upper buffer layer B2 disposed on an upper side of the optical waveguide substrate 1 in contact with the optical waveguide substrate 1, in which a coefficient of linear thermal expansion of the upper buffer layer B2 is set to be larger than a coefficient of linear thermal expansion of the lower buffer layer B1.

### TECHNICAL FIELD

The present invention relates to an optical waveguide device, and an optical modulation device and an optical transmission apparatus using the same, and particularly relates to an optical waveguide device including an optical waveguide substrate on which an optical waveguide is formed, a reinforcing substrate disposed under the optical waveguide substrate, a lower buffer layer disposed between the optical waveguide substrate and the reinforcing substrate to join both of the optical waveguide substrate and the reinforcing substrate to each other, and an upper buffer layer disposed on an upper side of the optical waveguide substrate in contact with the optical waveguide substrate.

### BACKGROUND ART

In the field of optical measurement technology or in the field of optical communication technology, optical waveguide devices such as an optical modulator using an optical waveguide substrate on which an optical waveguide is formed have been widely used. In a general optical waveguide device, an optical waveguide is formed on a substrate of lithium niobate (LN) or the like having an electro-optic effect, and an electrode that applies an electric field to the optical waveguide is formed on the substrate.

Patent Literatures No. 1 to 3 suggest a configuration of disposing buffer layers on and under an optical waveguide substrate with the optical waveguide substrate interposed between the buffer layers. Particularly, in a case where the optical waveguide substrate is a thin plate of several μm or lower, a reinforcing substrate is disposed to reinforce mechanical strength of the optical waveguide substrate. The lower buffer layer has a role of joining the optical waveguide substrate and the reinforcing substrate to each other and a role of suppressing absorption of a light wave propagating through the optical waveguide by the reinforcing substrate.

The upper buffer layer is a protective film that functions to suppress absorption of the light wave propagating through the optical waveguide by an electrode disposed on the optical waveguide substrate or scattering of the light wave propagating through the optical waveguide because of roughness of a surface of the optical waveguide.

Size reduction of the device itself is required for the optical waveguide device and an optical modulation device. As means for implementing this, it is suggested to strengthen confinement of light by setting a height or a width of the optical waveguide to approximately 1 μm or lower and to dispose the optical waveguide by bending the optical waveguide.

In Patent Literature No. 1, in a case where a thin optical waveguide substrate of several μm or lower is used, stress applied to the optical waveguide substrate by the buffer layers causes damage or characteristic deterioration to the optical waveguide substrate. Thus, configuring the upper buffer layer and the lower buffer layer with the same material and setting the same film thickness are disclosed.

However, in a case where Si, silicon on insulator (SOI; a substrate in which a silicon layer is formed on a silicon oxide), or the like is used in the reinforcing substrate, the reinforcing substrate has a higher refractive index than the optical waveguide substrate. Thus, an optical absorption loss is increased. Accordingly, it is required to set the thickness of the lower buffer layer to approximately 2 μm to 3 μm.

Furthermore, as disclosed in Patent Literature No. 1, in a case where a dense SiO₂ film having a thickness of 2 μm is formed on a substrate 1 of LN as a buffer layer, the LN substrate that is the optical waveguide substrate peels off because of internal stress caused by expansion or contraction of the buffer layer caused by a change in a temperature.

In order to suppress peeling of the optical waveguide substrate, Patent Literature No. 3 suggests forming a thickness d2 of an upper buffer layer B2 to be smaller than a thickness d1 of a lower buffer layer B1 (d2<d1) as illustrated in FIG. 1. Reference sign 1 denotes the optical waveguide substrate, reference sign 10 denotes the optical waveguide, and reference sign 11 denotes the reinforcing substrate.

In an optical modulator such as a high bandwidth-coherent driver modulator (HB-CDM), not only the optical waveguide device (chip) is reduced in size, but also the optical waveguide and the electrode are miniaturized and densely disposed. Thus, in a case where there is a difference in a coefficient of linear thermal expansion between constituent parts such as the optical waveguide substrate, the electrode, and the buffer layer constituting the optical waveguide, internal stress is generated between the constituent parts because of a change in the temperature, and so-called temperature drift that is fluctuation of a DC bias point related to optical modulation is likely to occur.

### Citation List

### Patent Literature

[Patent Literature No. 1] Japanese Laid-open Patent Publication No. 2021-105650
[Patent Literature No. 2] Japanese Laid-open Patent Publication No. 2021-173792
[Patent Literature No. 3] PCT/JP2022/16292 (international filing date: Mar. 30, 2022)

### SUMMARY OF INVENTION

### Technical Problem

An object to be solved by the present invention is to solve the above problem and to provide an optical waveguide device that suppresses temperature drift in a portion in which patterns of an optical waveguide and an electrode are densely disposed. Furthermore, an optical modulation device and an optical transmission apparatus using the optical waveguide device are provided.

### Solution to Problem

In order to solve the object, an optical waveguide device of the present invention, and an optical modulation device and an optical transmission apparatus using the same have the following technical features.

(1) An optical waveguide device includes an optical waveguide substrate on which an optical waveguide is formed, a reinforcing substrate disposed on a lower side of the optical waveguide substrate, a lower buffer layer disposed between the optical waveguide substrate and the reinforcing substrate to join both of the optical waveguide substrate and the reinforcing substrate to each other, and an upper buffer layer disposed on an upper side of the optical waveguide substrate in contact with the optical waveguide substrate, in which a coefficient of linear thermal expansion of the upper buffer layer is set to be larger than a coefficient of linear thermal expansion of the lower buffer layer.

(2) In the optical waveguide device according to (1), the upper buffer layer and the lower buffer layer are formed of different materials.

(3) In the optical waveguide device according to (2), the lower buffer layer is formed of one type of material, and in the upper buffer layer, two or more types of materials are used in a layered state or a mixed state.

(4) In the optical waveguide device according to (3), the upper buffer layer is formed in layers, and a layer closest to the optical waveguide substrate is set to have a largest coefficient of linear thermal expansion.

(5) In the optical waveguide device according to (1), the coefficient of linear thermal expansion of the upper buffer layer is smaller than a coefficient of linear thermal expansion of the optical waveguide substrate.

(6) In the optical waveguide device according to (1), an electrode is disposed on the upper side of the optical waveguide substrate, and the upper buffer layer is disposed to cover the optical waveguide and the electrode.

(7) In the optical waveguide device according to (6), a thickness of the upper buffer layer is 1 μm or higher.

(8) In the optical waveguide device according to (1), a thickness of the lower buffer layer is set to 1 μm or higher, and a thickness of the upper buffer layer is set to 1 μm or lower.

(9) In the optical waveguide device according to (1), density of the lower buffer layer is higher than density of the upper buffer layer.

(10) In the optical waveguide device according to (1), electrical resistivity of the upper buffer layer and the lower buffer layer is 10⁸ Ωcm or higher and 10¹⁶ Ωcm or lower.

(11) An optical modulation device includes the optical waveguide device according to any one of (1) to (9), a case accommodating the optical waveguide device, and an optical fiber through which a light wave is input into the optical waveguide or output from the optical waveguide.

(12) In the optical modulation device according to (11), the optical waveguide device includes a modulation electrode for modulating a light wave propagating through the optical waveguide, and an electronic circuit that amplifies a modulation signal to be input into the modulation electrode of the optical waveguide device is provided inside the case.

(13) An optical transmission apparatus includes the optical modulation device according to (12), and an electronic circuit that outputs a modulation signal causing the optical modulation device to perform a modulation operation.

### Advantageous Effects of Invention

In the present invention, an optical waveguide device includes an optical waveguide substrate on which an optical waveguide is formed, a reinforcing substrate disposed under the optical waveguide substrate, a lower buffer layer disposed between the optical waveguide substrate and the reinforcing substrate to join both of the optical waveguide substrate and the reinforcing substrate to each other, and an upper buffer layer disposed on an upper side of the optical waveguide substrate in contact with the optical waveguide substrate, in which a coefficient of linear thermal expansion of the upper buffer layer is set to be larger than a coefficient of linear thermal expansion of the lower buffer layer. Thus, it is possible to alleviate stress applied to the optical waveguide substrate by the upper buffer layer and suppress temperature drift.

Furthermore, the optical waveguide device having such advantageous characteristics can also be used to provide an optical modulation device and an optical transmission apparatus that achieve the same effect.

### BRIEF DESCRIPTION OF DRAWINGS

FIG. 1 is a cross section view illustrating an example of an optical waveguide device according to Patent Literature No. 3.

FIG. 2 is a cross section view illustrating an example of an optical waveguide device of the present invention.

FIGS. 3A and 3B are diagrams for describing states of an upper buffer layer (a layered state in FIG. 3A, and a mixed state in FIG. 3B).

FIG. 4 is a diagram for describing a manufacturing process of the optical waveguide device of the present invention.

FIG. 5 is a diagram for describing the manufacturing process continuing from FIG. 4.

FIG. 6 is a diagram illustrating another shape (1) of the upper buffer layer of the optical waveguide device of the present invention.

FIG. 7 is a diagram illustrating another shape (2) of the upper buffer layer of the optical waveguide device of the present invention.

FIG. 8 is a diagram illustrating another shape (3) of the upper buffer layer of the optical waveguide device of the present invention.

FIG. 9 is a graph illustrating a relationship between a change in a thickness of the upper buffer layer and a drive voltage (V_{Π}) applied to an optical waveguide.

FIG. 10 is a plan view for describing an optical modulation device and an optical transmission apparatus of the present invention.

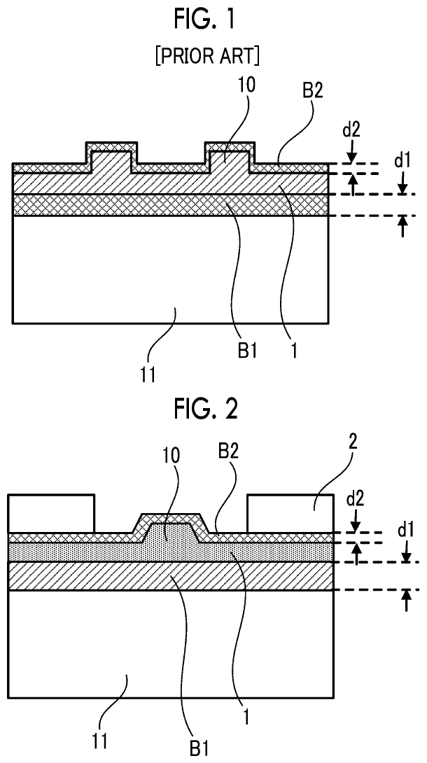

### DESCRIPTION OF EMBODIMENTS

Hereinafter, an optical waveguide device of the present invention will be described in detail using preferred examples.

A cross section view illustrating an example of the optical waveguide device of the present invention is illustrated in FIG. 2.

An optical waveguide device of the present invention includes an optical waveguide substrate 1 on which an optical waveguide 10 is formed, a reinforcing substrate 11 disposed under the optical waveguide substrate 1, a lower buffer layer B1 disposed between the optical waveguide substrate 1 and the reinforcing substrate 11 to join both of the optical waveguide substrate 1 and the reinforcing substrate 11 to each other, and an upper buffer layer B2 disposed on an upper side of the optical waveguide substrate 1 in contact with the optical waveguide substrate 1, in which a coefficient of linear thermal expansion of the upper buffer layer B2 is set to be larger than a coefficient of linear thermal expansion of the lower buffer layer B1.

The optical waveguide device is obtained by forming a plurality of optical waveguide devices on a substrate (the optical waveguide substrate or the reinforcing substrate) having a shape of a wafer and then cutting the wafer to form individual optical waveguide devices (chips). The optical waveguide device of the present invention also means the cut chip itself.

As the optical waveguide substrate 1 used in the optical waveguide device of the present invention, a substrate having an electro-optic effect can be used. Specifically, substrates of single crystal materials such as a lithium niobate (LN), a lithium tantalate (LT), a lead lanthanum zirconate titanate (PLZT), and the like or base materials obtained by doping these substrate materials with MgO or the like can be used. In addition, these materials can be formed into films using a sputtering method, a vapor deposition method, or a vapor-phase growth method such as a CVD method. Furthermore, semiconductor substrates and the like can be used.

As a method of forming the optical waveguide 10, a rib type optical waveguide obtained by forming a part corresponding to the optical waveguide to have a protruding shape in the substrate by, for example, etching the substrate 1 other than the optical waveguide or by forming grooves on both sides of the optical waveguide can be used. Furthermore, a refractive index can be further increased by diffusing Ti or the like on a surface of the substrate using a thermal diffusion method, a proton exchange method, or the like in accordance with the rib type optical waveguide. In addition, while the optical waveguide can be formed by forming a high-refractive index region obtained by thermally diffusing Ti or the like on the substrate 1, the rib type optical waveguide is more preferable because confinement of light is increased in the micro optical waveguide having a width and a height of approximately 1 μm.

A thickness of the substrate (thin plate) 1 on which the optical waveguide 10 is formed is set to be 10 μm or less, more preferably 5 μm or less, and still more preferably 1 μm or less in order to achieve velocity matching between a microwave of a modulation signal and a light wave. In addition, a height of the rib type optical waveguide is set to be 4 μm or less, more preferably 3 μm or less, and still more preferably 1 μm or less or 0.4 μm or less. Generally, as the optical waveguide substrate 1 is thinner, the optical waveguide substrate 1 is more likely affected by stress caused by a thin film such as the lower buffer layer and the upper buffer layer formed in contact with the optical waveguide substrate 1.

In the optical waveguide substrate 1 on which the optical waveguide is formed, the reinforcing substrate 11 is joined to a lower side of the optical waveguide substrate 1 through the lower buffer layer B1, as illustrated in FIG. 2, in order to increase mechanical strength. The lower buffer layer B1 and the reinforcing substrate 11 are adhesively fixed via direct joining or through an adhesive layer of resin or the like. The reinforcing substrate to be directly joined preferably has, but is not limited to, a lower refractive index than the optical waveguide or than the substrate on which the optical waveguide is formed. In addition, a substrate including a material, for example, an oxide layer of crystal or of glass, having a similar coefficient of linear thermal expansion to the optical waveguide or the like is preferably used as the reinforcing substrate. Furthermore, the same LN substrate as the optical waveguide substrate, or a composite substrate obtained by forming a silicon oxide layer on a silicon substrate and a composite substrate obtained by forming a silicon oxide layer on an LN substrate, which are abbreviated to SOI and LNOI, can also be used.

As a feature of the optical waveguide device (chip) of the present invention, the coefficient of linear thermal expansion of the upper buffer layer B2 is set to be larger than the coefficient of linear thermal expansion of the lower buffer layer B1.

A material used in the buffer layer is preferably a material having a lower refractive index and higher transparency than the optical waveguide substrate 1 of LN or the like. For example, an oxide or a fluoride of a metal element of Groups 1 to 17 of the periodic table such as SiO₂, Al₂O₃, MgF₂, La₂O₃, ZnO, HfO₂, MgO, CaF₂, or Y₂O₃ can be used.

The buffer layer is formed as a film using various methods such as vapor-phase growth such as CVD, sputtering, and vacuum vapor deposition. In the case of forming the film using vapor-phase growth or sputtering, density of the film body is increased, compared to that of the film of vacuum vapor deposition. As will be described later, density of the lower buffer layer B1 is set to be higher than density of the upper buffer layer B2.

For example, a coefficient of linear thermal expansion of SiO₂ is 0.5×10⁻⁶/° C., and a coefficient of linear thermal expansion of Al₂O₃ is 7.0×10⁻⁶/° C. Thus, by using SiO₂ in the lower buffer layer B1 and using Al₂O₃ in the upper buffer layer B2, the coefficient of linear thermal expansion of the upper buffer layer B2 can be set to be larger than the coefficient of linear thermal expansion the lower buffer layer B1. From another viewpoint, the present invention can be said to be to alleviate stress applied to the optical waveguide substrate by the upper buffer layer, by setting a difference in the coefficient of linear thermal expansion between the upper buffer layer and the optical waveguide substrate to be smaller than a difference in the coefficient of linear thermal expansion between the lower buffer layer and the optical waveguide substrate.

For example, a coefficient of linear thermal expansion of the LN substrate constituting the optical waveguide substrate 1 is 15.4×10⁻⁶/° C. while varying depending on a crystal direction. In addition, a coefficient of linear thermal expansion of Au constituting an electrode is 14.2×10⁻⁶/° C. Thus, the coefficient of linear thermal expansion of the buffer layer of SiO₂, Al₂O₃, or the like is generally smaller than the coefficient of linear thermal expansion of the optical waveguide substrate or the electrode.

The lower buffer layer B1 is required to firmly bond the optical waveguide substrate 1 and the reinforcing substrate 11 to each other and thus, is formed of a single material with high density. Thus, stress caused by a difference in the coefficient of linear thermal expansion is generated between the lower buffer layer B1 and the optical waveguide substrate 1.

Meanwhile, the upper buffer layer B2 is a layer having a higher coefficient of linear thermal expansion than the lower buffer layer B1. Accordingly, the stress applied to the optical waveguide substrate 1 by the upper buffer layer B2 can be alleviated, and damage or a temperature drift phenomenon applied to the optical waveguide substrate can be suppressed.

In a case where the coefficient of linear thermal expansion of the upper buffer layer B2 is the same as or smaller than the coefficient of linear thermal expansion of the lower buffer layer B1, the optical waveguide substrate not only receives strong stress from the lower buffer layer B1 but also receives large stress from the upper buffer layer B2 having a larger difference in the coefficient of linear thermal expansion, because the optical waveguide substrate is in close contact with the lower buffer layer B1. Thus, damage or the temperature drift phenomenon to the optical waveguide substrate is more noticeable.

For a thickness of the upper or lower buffer layer, a thickness d2 of the upper buffer layer B2 is adjusted to be in a relationship of d2<d1 compared to a thickness d1 of the lower buffer layer B1, as illustrated in FIG. 2. For example, configuring the upper buffer layer B2 to have a small thickness achieves an effect of reducing the stress applied to the optical waveguide substrate 1 from the upper buffer layer, as in Patent Literature No. 3. However, as will be described later, the optical waveguide device of the present invention is not limited to the relationship of d2<d1 and can also be applied to, for example, a condition of d2>d1 depending on a case.

The thickness of the lower buffer layer B1 is set to 1 μm or higher and more preferably 2 μm or higher in order to suppress optical absorption in the reinforcing substrate 11.

In addition, the lower buffer layer B1 has a role of a joint layer with the reinforcing substrate 11 and thus, desirably has higher density. In a case where the density of the lower buffer layer B1 is low (thin film), joint strength between the optical waveguide substrate 1 and the reinforcing substrate 11 is reduced, and there is also a risk of peeling between the reinforcing substrate 11 and the optical waveguide substrate (LN substrate) 1 in polishing a surface of the optical waveguide substrate 1 to thin the optical waveguide substrate 1.

The thickness of the upper buffer layer B2 is set to 1 μm or lower and more preferably 0.5 μm or lower because stress applied to the optical waveguide can be alleviated more as the upper buffer layer near the optical waveguide is thinner. However, in the optical waveguide device of the present invention, as will be described later, the thickness of the upper buffer layer B2 is not limited to 1 μm or lower and may be larger than 1 μm depending on a condition.

As described above, the lower buffer layer B1 is desirably formed of one type of material from a viewpoint of forming a high density joint layer. Meanwhile, the upper buffer layer B2 can be formed of one type of material such as Al₂O₃, or two or more types of materials can be used in combination. Combining two types of materials enables setting of a higher coefficient of linear thermal expansion.

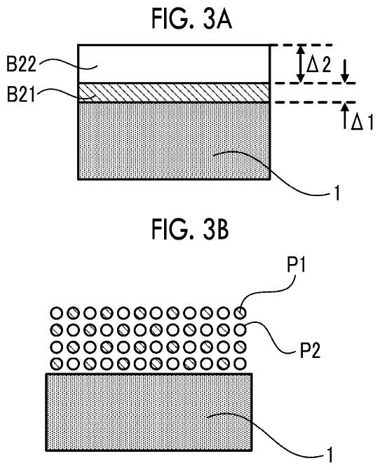

In a case where the upper buffer layer is formed using two or more types of materials, a method of overlaying different buffer layers on each other in layers as illustrated in FIG. 3A can be used, or different materials (P1, P2) in a mixed state as illustrated in FIG. 3B can be used. In addition, in order to further reduce the stress applied to the optical waveguide substrate 1 by the upper buffer layer B2, the upper buffer layer B2 is preferably set to have lower density than the lower buffer layer B1.

As in FIG. 3A, in a case where the upper buffer layer is formed by overlaying in layers, a layer closer to the optical waveguide substrate 1 is preferably more thinly formed. Accordingly, stress caused by the buffer layer (a part of the layers) in contact with the optical waveguide substrate 1 can be further reduced. In addition, the coefficient of linear thermal expansion of each layer is set such that the coefficient of linear thermal expansion is larger as the layer is closer to the optical waveguide substrate 1. Accordingly, a difference in the coefficient of linear thermal expansion between the buffer layer (a part of the layers) closest to the optical waveguide substrate 1 and the optical waveguide substrate 1 can be further reduced. Thus, stress applied to the optical waveguide substrate 1 by the buffer layer closest to the optical waveguide substrate 1 can be alleviated.

Electrical resistivity of the upper or lower buffer layer is preferably set to 10⁸ Ωcm or higher and 10¹⁶ Ωcm or lower.

Providing the buffer layer with such electrical resistivity can suppress a pyroelectric effect such as a DC drift phenomenon of the LN substrate or the like as disclosed in Patent Literature No. 1 or 2. Particularly, the upper buffer layer B2 preferably has the above electrical resistivity because the electrode is disposed on the upper side of the optical waveguide substrate 1.

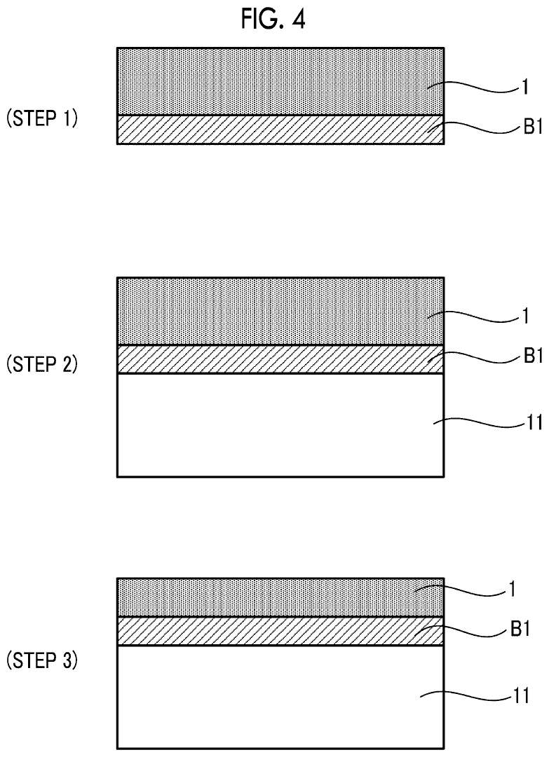

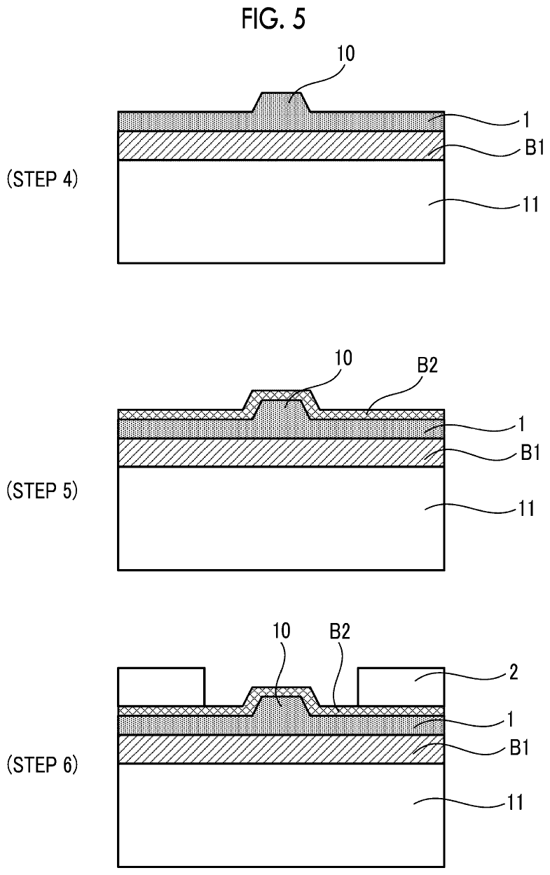

Next, manufacturing steps of the optical waveguide device of the present invention will be described with reference to FIGS. 4 and 5.

In a first step (STEP 1), a layer (for example, SiO₂) used as the lower buffer layer B1 is formed using sputtering or the like with respect to a layer (for example, an LN layer) used as the optical waveguide substrate 1.

In a second step (STEP 2), a lower surface of the layer used as the lower buffer layer B1 is directly joined to an upper surface of the reinforcing substrate 11 using a direct joining method. The direct joining method is a method suitable for joining materials of different types. As the direct joining method, a plasma-activated joining method or a fast atom beam (FAB) method can be used, as appropriate, as illustrated in Patent Literature No. 1.

In a third step (STEP 3), the optical waveguide substrate 1 is processed to have an appropriate thickness by polishing the upper side of the optical waveguide substrate 1.

In a fourth step (STEP 4), the optical waveguide (10) is formed on the optical waveguide substrate 1 by removing a part other than the rib portion 10 using, for example, dry etching.

In a fifth step (STEP 5), the upper buffer layer B2 is deposited on the optical waveguide substrate 1 using, for example, vacuum vapor deposition.

In a sixth step (STEP 6), for example, electrodes 2 (for example, a signal electrode and a ground electrode, or DC bias electrodes) are formed on the upper buffer layer B2.

While an example of forming the upper buffer layer B2 on the entire upper surface of the optical waveguide substrate 1 as illustrated in FIG. 2 has been described for the optical waveguide device of the present invention, the present invention is not limited to this.

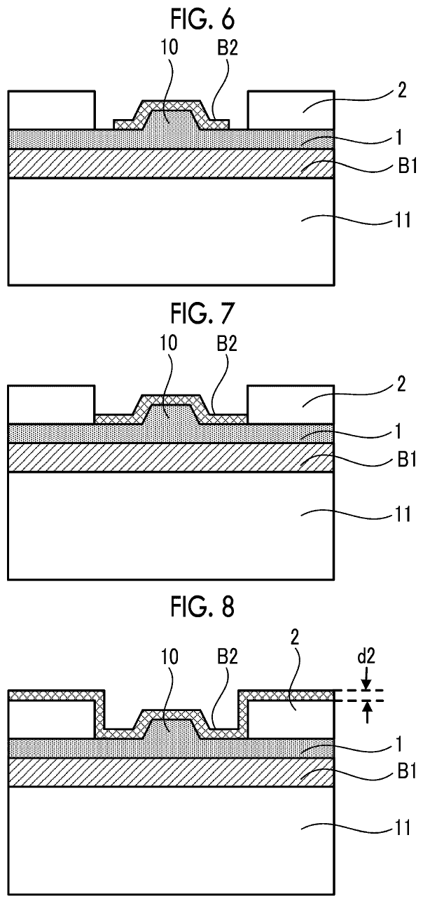

In FIG. 6, the upper buffer layer B2 is formed only on the optical waveguide 10 and near the optical waveguide 10. As in FIG. 6, in a case where the upper buffer layer covers the optical waveguide, scattering of the light wave caused by roughness of a surface of the optical waveguide can be effectively suppressed. For example, the upper buffer layer B2 is desirably formed to have a width that is 1.5 times or more than a mode field diameter (MFD) of the light wave propagating through the optical waveguide.

As in FIG. 7, the upper buffer layer B2 can also be formed to be disposed within a wide range including the optical waveguide 10, for example, between the electrodes 2 between which the optical waveguide 10 is interposed. In FIG. 6, the upper buffer layer B2 is required to be accurately positioned with respect to a position of the optical waveguide 10. However, in FIG. 7, positioning accuracy can be set to be relatively low, considering positional accuracy of manufacturing in a manufacturing process.

As illustrated in FIGS. 6 and 7, narrowing a range in which the upper buffer layer B2 is formed can suppress stress applied to the optical waveguide 10 or the optical waveguide substrate 1 by the upper buffer layer B2. The stress in FIG. 6 is more reduced than the stress in FIG. 7.

In FIG. 8, the upper buffer layer B2 is configured to cover up to the electrodes 2.

As described above, the coefficient of linear thermal expansion of the material used in the buffer layer is lower than the coefficient of linear thermal expansion of the optical waveguide substrate (for example, LN) or the electrode (for example, Au). A difference between the coefficient of linear thermal expansion of the optical waveguide substrate and the coefficient of linear thermal expansion of the electrode may be smaller than the difference between the coefficient of linear thermal expansion of the optical waveguide substrate and the coefficient of linear thermal expansion of the upper buffer layer. Thus, in a case where the thickness d2 of the upper buffer layer is increased, changing the material in contact with the optical waveguide substrate 1 to the electrodes 2 from the upper buffer layer B2 can further suppress the stress applied to the optical waveguide substrate.

In addition, as in FIG. 2, in a case where the electrodes 2 are disposed on the upper buffer layer B2, an electric field formed by the electrodes 2 is less likely to be efficiently applied to the optical waveguide 10 as the thickness d2 of the upper buffer layer B2 is larger.

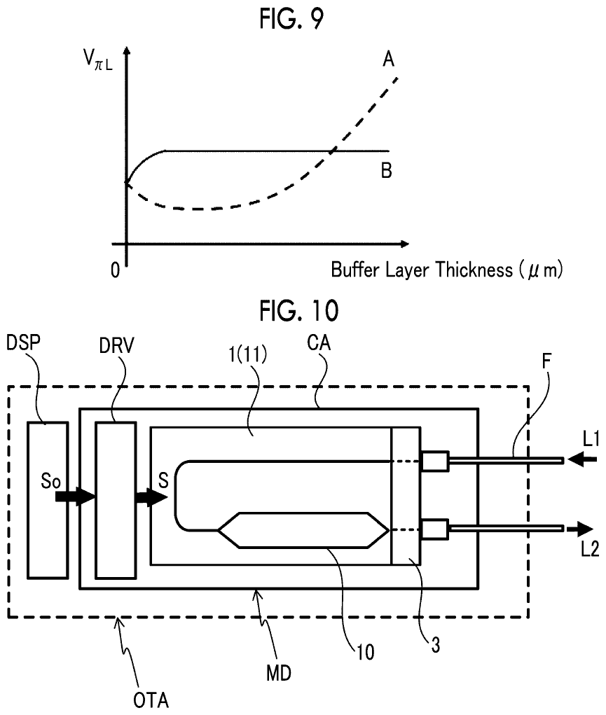

FIG. 9 illustrates a change in electric field efficiency per unit length with respect to a change in the thickness (μm) of the upper buffer layer B2 with a variable electrode clearance and a constant optical loss. The electric field efficiency is indicated by a value of a drive voltage Vi of an optical modulator per unit length (V_{Π}_{_{L}}: unit V/m).

Graph A in FIG. 9 is a graph in a case where the upper buffer layer B2 is present on a lower side of the electrodes 2 (refer to FIG. 2). Graph B is a graph in a case where the upper buffer layer B2 is present on an upper side of the electrodes 2 (refer to FIG. 8).

With reference to Graphs A and B in FIG. 9, the thickness d2 of the buffer layer at an intersection between Graphs A and B at which the drive voltage VIL of both graphs is reversed is 1 μm or higher and has a numerical value of 2 μm to 5 μm, while depending on a used material. For example, in a case where the thickness d2 of the upper buffer layer is small like 1 μm or lower, any of the lower side or the upper side of the electrodes 2 may be covered. However, in a case where the thickness of the upper buffer layer B2 exceeds 1 μm, a configuration of forming the upper buffer layer B2 on the upper side of the electrodes 2 as in FIG. 8 is preferably adopted.

Next, examples of applying the optical waveguide device of the present invention to an optical modulation device and to an optical transmission apparatus will be described. While the optical modulation device using the optical waveguide device illustrated in FIG. 2 will be described below, the present invention is not limited to the optical modulation device in FIG. 2 and can also be applied to an optical phase modulator, an optical modulator having a polarization combining function, an optical waveguide device in which a larger number of Mach-Zehnder type optical waveguides are integrated, a device joined to an optical waveguide device including other materials such as silicon, a device used as a sensor, and the like. Furthermore, the present invention can also be applied to an HB-CDM.

As illustrated in FIG. 10, the optical waveguide device includes the optical waveguide 10 formed on the optical waveguide substrate 1, and a modulation electrode (not illustrated) that modulates the light wave propagating through the optical waveguide 10. The optical waveguide device is accommodated inside a case CA. Furthermore, an optical modulation device MD can be configured by providing an optical fiber (F) through which the light wave is input into the optical waveguide or output from the optical waveguide. The optical fiber F can be optically coupled to the optical waveguide inside the optical waveguide device using an optical block including an optical lens, a lens barrel, and the like. In FIG. 10, the optical fiber F is introduced into the case through a through-hole that penetrates through a side wall of the case CA, and is directly joined to the optical waveguide substrate 1. In addition, a reinforcing member 3 can be disposed to overlap along an end surface of the optical waveguide substrate 1 in order to stably join the optical fiber to the optical block.

An optical transmission apparatus OTA can be configured by connecting, to the optical modulation device MD, an electronic circuit (digital signal processor DSP) that outputs a modulation signal So causing the optical modulation device MD to perform a modulation operation. In order to obtain a modulation signal S to be applied to the optical waveguide device, it is required to amplify the modulation signal So output from the digital signal processor DSP. Thus, in FIG. 10, the modulation signal is amplified using a driver circuit DRV. The driver circuit DRV and the digital signal processor DSP can be disposed outside the case CA or can be disposed inside the case CA. Particularly, disposing the driver circuit DRV inside the case can further reduce a propagation loss of the modulation signal from the driver circuit.

### Industrial Applicability

As described above, according to the present invention, it is possible to provide an optical waveguide device that suppresses temperature drift in a portion in which patterns of an optical waveguide and an electrode are densely disposed. Furthermore, it is possible to provide an optical modulation device and an optical transmission apparatus using the optical waveguide device.

### REFERENCE SIGNS LIST

1: Substrate (thin plate, film body) on which optical waveguide is formed
10: Optical waveguide
11: Reinforcing substrate
B1: Lower buffer layer
B2: Upper buffer layer
F: Optical fiber
CA: Case
MD: Optical modulation device
DRV: Driver circuit
DSP: Digital signal processor
OTA: Optical transmission apparatus

1. An optical waveguide device comprising:
an optical waveguide substrate on which an optical waveguide is formed;
a reinforcing substrate disposed under the optical waveguide substrate;
a lower buffer layer disposed between the optical waveguide substrate and the reinforcing substrate to join both of the optical waveguide substrate and the reinforcing substrate to each other; and
an upper buffer layer disposed on an upper side of the optical waveguide substrate in contact with the optical waveguide substrate,
wherein a coefficient of linear thermal expansion of the upper buffer layer is set to be larger than a coefficient of linear thermal expansion of the lower buffer layer.

2. The optical waveguide device according to claim 1,
wherein the upper buffer layer and the lower buffer layer are formed of different materials.

3. The optical waveguide device according to claim 2,
wherein the lower buffer layer is formed of one type of material, and
in the upper buffer layer, two or more types of materials are used in a layered state or a mixed state.

4. The optical waveguide device according to claim 3,
wherein the upper buffer layer is formed in layers, and a layer closest to the optical waveguide substrate is set to have a largest coefficient of linear thermal expansion.

5. The optical waveguide device according to claim 1,
wherein the coefficient of linear thermal expansion of the upper buffer layer is smaller than a coefficient of linear thermal expansion of the optical waveguide substrate.

6. The optical waveguide device according to claim 1,
wherein an electrode is disposed on the upper side of the optical waveguide substrate, and
the upper buffer layer is disposed to cover the optical waveguide and the electrode.

7. The optical waveguide device according to claim 6,
wherein a thickness of the upper buffer layer is 1 μm or higher.

8. The optical waveguide device according to claim 1,
wherein a thickness of the lower buffer layer is set to 1 μm or higher, and
a thickness of the upper buffer layer is set to 1 μm or lower.

9. The optical waveguide device according to claim 1,
wherein density of the lower buffer layer is higher than density of the upper buffer layer.

10. The optical waveguide device according to claim 1,
wherein electrical resistivity of the upper buffer layer and the lower buffer layer is 10⁸ Ωcm or higher and 10¹⁶ Ωcm or lower.

11. An optical modulation device comprising:
the optical waveguide device according to claim 1;
a case accommodating the optical waveguide device; and
an optical fiber through which a light wave is input into the optical waveguide or output from the optical waveguide.

12. The optical modulation device according to claim 11,
wherein the optical waveguide device includes a modulation electrode for modulating a light wave propagating through the optical waveguide, and
an electronic circuit that amplifies a modulation signal to be input into the modulation electrode of the optical waveguide device is provided inside the case.

13. An optical transmission apparatus comprising:
the optical modulation device according to claim 12; and
an electronic circuit that outputs a modulation signal causing the optical modulation device to perform a modulation operation.
